(19) United States
(12) Patent Application Publication
(10) Pub. No.: US 2015/0231875 A1
(43) Pub. Date: Aug. 20, 2015

(54) WEB OFFSET PRINTING MACHINE AND METHOD FOR PRINTING A MATERIAL WEB

(71) Applicant: STS Concept GmbH, Schwerin (DE)

(72) Inventor: Stephan Schuetze, Schwerin (DE)

(21) Appl. No.: 14/415,833

(22) PCT Filed: Jun. 14, 2013
(86) PCT No.: PCT/EP2013/062374

§ 371 Date: Jan. 20, 2015

(30) Foreign Application Priority Data
Jul. 18, 2012 (DE) 20 2012 102 681.3

(51) Int. Cl. B41F 7/04

(52) U.S. Cl. CPC B41F 7/04

(57) ABSTRACT

The invention relates to a web offset printing machine (10) which is characterized in that the web offset printing machine (10) has at least one coating module (23) for coating a printed material web (3) on one side. For further improvement the web offset printing machine (10) can have a rolling-up module (16) for rolling up the printed material web (3) and/or a cutting device (17) for cutting flat printed products from the printed material web (3).

The invention relates to a web offset printing machine for printing a flat material web of cardboard or liner for corrugated board or packagings, which is unrolled from a roll, comprising at least one printing mechanism for printing an unrolled section of the material web and comprising an unrolling apparatus for unrolling the material web from the roll and for supplying the unrolled material web to the printing mechanism. The invention further relates to a method for printing a flat material web, in particular cardboard or liner for corrugated board or packagings, where the material web is unrolled from a roll and an unrolled section of the material web is printed.

Web offset printing machines comprising at least one printing mechanism and methods for printing flat material webs are generally known and are used frequently to print printed products at high speed. Printed products which are printed for example on web offset printing machines are pages for daily newspapers or for diaries. Two rotating printing cylinders arranged opposite to one another between which the material web runs in a processing direction are used for the simultaneous printing on both sides and transporting of the material web. The printing cylinders rotate in opposite directions and transport the material web in the processing direction.

As a result of the low grammage of paper used for daily newspapers or diaries, the material web is very light so that it can be printed at high speed. For example, the printing cylinders can be operated with up to 50,000 rollovers per hour, where the printing cylinders can have a diameter of, for example, 125, 250, 500 or 1000 mm.

The material web to be printed is therefore moved at high speed through the printing apparatus. Thin material webs, such as for example newsprint are highly flexible and can compensate for at least small speed differences inside or upstream or downstream of the printing apparatus through deformation. Materials having a higher stiffness however cannot be easily printed at such high speeds.

Furthermore, web offset printing machines are known which can print cardboard or liner for corrugated board or packagings on one side at lower speed. However, printed products are also intended to be processed in other ways apart from by printing. It is therefore the object of the invention to provide a web offset printing machine and a method which can be used more flexibly for printing material webs.

The object is solved for the initially mentioned web offset printing machine according to the invention whereby the web offset printing machine is configured with a coating module for coating the printed material web on one side, where the coating module is located downstream of the printing mechanism. For the method mentioned initially the object is solved according to the invention whereby the printed section is coated on one side.

By using the coating module the material web and in particular the printed side of the material web can be provided with a coating and by this means for example the visual impression of the printed product can be improved by adding a gloss effect.

Printed products which are printed on one side and coated cannot be fabricated with the existing web offset printing machines since existing web offset printing machines have hitherto only been used for printing printed products which can be used without coating. If the printed products are nevertheless to be coated, this takes place offline, therefore on a separate coating machine. Web offset printing machines with coating modules to which the printed material web is automatically supplied after printing are not known in the prior art. The solution according to the invention can be further improved by various embodiments which are each advantageous per se and which can be arbitrarily combined with one another. The embodiments and the advantages associated with them are discussed in the following.

According to a first embodiment, the web offset printing machine can be configured with a coating module for coating the printed material web on at least one side. In particular, the coating module can be located downstream of the printing apparatus in the processing direction so that already printed sections of the material web can be automatically supplied to the coating module by the printing apparatus.

The coating module can be configured to handle and coat on one side printed material webs of cardboard or liner, i.e. having a high grammage of for example 100 g/m², 200 g/m², 410 g/m² or as far as 800 g/m². Known coating modules do not handle and coat such heavy and consequently stiffer roll material such as the material web but merely sheet material having a comparable grammage. The mass which can be handled with the coating module according to the invention can therefore be greater than for known coating modules.

In order to be able to apply further coatings, the web offset printing machine can have further coating modules to which the material web which has been printed, and where possible already coated once or several times, is supplied during operation.

The coating module can comprise a coating unit which coats the printed material web on one side during operation and a drying device located downstream of the coating unit in the processing direction for drying the coated material web. The drying device can, for example, dry the material web thermally, possibly with the aid of radiant heaters, a hot blower or with a drying cylinder which contacts the material web during operation and which is heated, or with the aid of a UV emitter. The coating is dried more rapidly due to the drying device so that the coated material web can be supplied promptly to further processing stations of the web offset printing machine or another machine.

Furthermore, the web offset printing machine can comprise a drying device which is located downstream of the printing apparatus and which is configured to dry the ink printed on one side of the material web during operation. The drying device can, for example, dry the ink thermally so that this does not become detached when handling the printed material web and, for example, stay adhered to the hands of a person handling the material web. The drying module can be disposed between the printing apparatus and the coating module so that it dries the printing ink before the printed material web is supplied to the coating module. This prevents the ink which has not yet been dried and/or fixed mixing with the applied coating and as a result, possibly running.

In order to be able to further process the dried material web as rapidly as possible, the web offset printing machine can have a cooling module located downstream of the drying device for cooling the dried material web. If the material web is too warm for the further processing after the drying, the cooling module can promptly reduce the temperature of the material web. The cooling module can, for example, be disposed between the drying device which dries the printing ink and the coating module or downstream of the drying device which dries the coating. For cooling the material web, the cooling module can use a cooling fluid which directly cools the material web during operation. Additionally or alternatively the cooling module can comprise a cooling cylinder which cools the cooling fluid during operation and which contacts the material web for cooling.

In order to simply handle the ready printed and coated material web and for example be able to supply it to further production steps, the web offset printing machine can comprise a rolling-up module provided at the end of the web offset printing machine in the processing direction for rolling up the printed material web onto a roll. Many processors of printed materials can manufacture more economically with printed material webs rolled up on a roll than, for example, with cut printed products. For example, a manufacturer of corrugated board can apply the rolled-up printed and optionally coated material web directly as an outer cover to a corrugated cardboard during the manufacture of corrugated board. The printed outer cover can thus be produced in a roll-to-roll laminating process onto the corrugated material and consequently the corrugated board can be produced in a roll-to-roll process.

If however cut printed products are desired, the web offset printing machine can comprise a cutting apparatus provided at the end of the web offset printing machine in the processing direction for cutting flat printed products from the printed and optionally coated material web.

The rolling-up module and the cutting apparatus can be configured to be exchangeable with respect to one another so that printed products can be manufactured on the roll or cut as ordered.

The initially mentioned printing mechanism of the web offset printing machine can be configured to transfer the material web printed on one side to the coating module without the printed material web needing to be handled manually for this purpose. The printing mechanism can be configured with a transfer mechanism and/or the coating module can be configured with a transport or takeover mechanism for this purpose.

Furthermore, the material web can be printed on one side and the printing mechanism can print the unrolled material web, in particular cardboard or liner for corrugated board or packagings, on one side, where the printing mechanism is configured for this purpose with a printing cylinder for printing the material web on one side and with a counterpressure cylinder for pressing the material web onto the printing cylinder. By using only one printing cylinder with a counterpressure cylinder instead of two printing cylinders, the unrolled material web can be printed on one side with the web offset printing machine, which was not possible with conventional web offset printing machines having two printing cylinders. Printing cylinders specifically cannot be operated dry, i.e. without being wetted with printing ink, since the elastic material required for transferring the printing ink, which surrounds the printing cylinder on its lateral surface, would be damaged during dry operation.

Since the printing apparatus is configured for printing material webs of cardboard or liner, i.e. having a high grammage of, for example, 100 g/m², 200 g/m², 410 g/m² or up to 800 g/m², cardboard goods or liner for corrugated board or packagings can also be printed. Material webs having a high grammage are generally stiffer than material webs having a lower grammage.

In order to be able to print products having the said high grammages, the printing apparatus is preferably configured to operate the printing cylinder and the counterpressure cylinder more slowly and for example, at a maximum of 20,000, 25,000 or 30,000 rollovers per hour.

For printing on one side the printing apparatus has only one printing cylinder interacting with the counterpressure cylinder.

In order to be able to print the material web more flexibly, the web offset printing machine can be configured to print sections of the material web having different lengths. In particular, the length of the sections to be printed can differ from a circumference of the printing cylinder or cylinders, where the length of the sections to be printed is variably adjustable without the printing cylinder or cylinders needing to be exchanged. For example, the circumference of the printing cylinder which is provided with a printing plate can be 1.5 m. The length of the section to be printed can differ from this circumference and in particular can be smaller and for example, can be 1 m.

In order that the material web can be printed with the web offset printing machine, the web offset printing machine can comprise a Pilger step feeding unit and optionally a Pilger step extraction unit. The printing mechanism or the printing mechanisms can be provided downstream of the Pilger step feeding unit in the processing direction.

In the processing direction upstream of the Pilger step feeding unit, the material web can be processed continuously, i.e. uniformly and for example be transported. Downstream of the Pilger step feeding unit, the material web can be processed discontinuously and for example transported. Consequently the material web can be stopped when printing when the section to be printed is printed. If the section to be printed is shorter than the circumference of the printing cylinder or than the length of the printing plate, the printing process can be continued as soon as the printing cylinder has completed its revolution.

In order to be able to continue the printing at a predefined point on the material web, the material web can be withdrawn contrary to the processing direction before the printing process is continued and for example, before the printing cylinder has completed its revolution.

The material web can be processed discontinuously as far as the Pilger step extraction unit. After the Pilger step extraction unit the material web can again be processed continuously and in particular transported and therefore coated.

The embodiment of the web offset printing machine described above with the Pilger step feeding unit and optionally also the Pilger step extraction unit with which sections of the material web of different length can be printed is advantageous when taken by itself and independently of the further embodiments described.

The invention is explained hereinafter as an example by means of embodiments with reference to the drawings. The various features of the embodiments can be combined independently of one another as has already been set out in the individual advantageous embodiments.

In the figures:

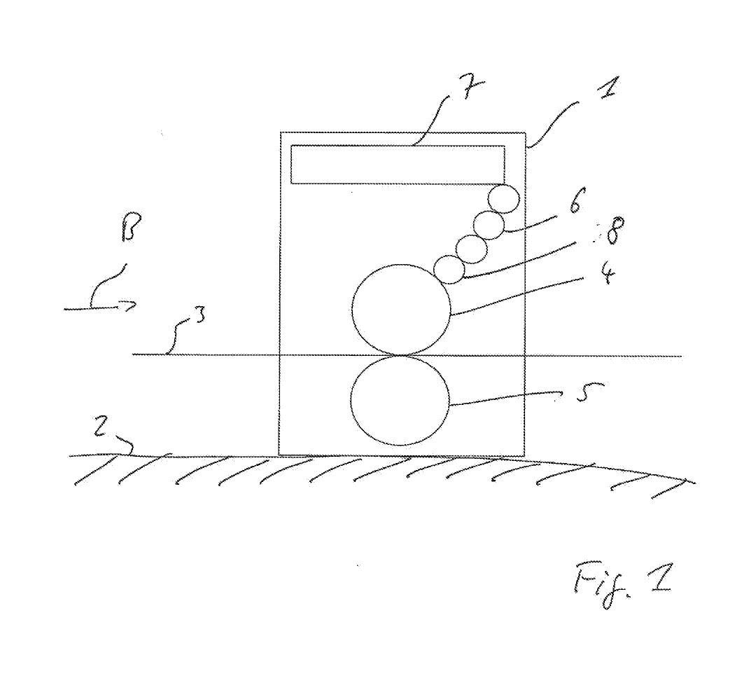

FIG. 1 shows a schematic view of an exemplary embodiment of a printing mechanism of the web offset printing machine according to the invention;

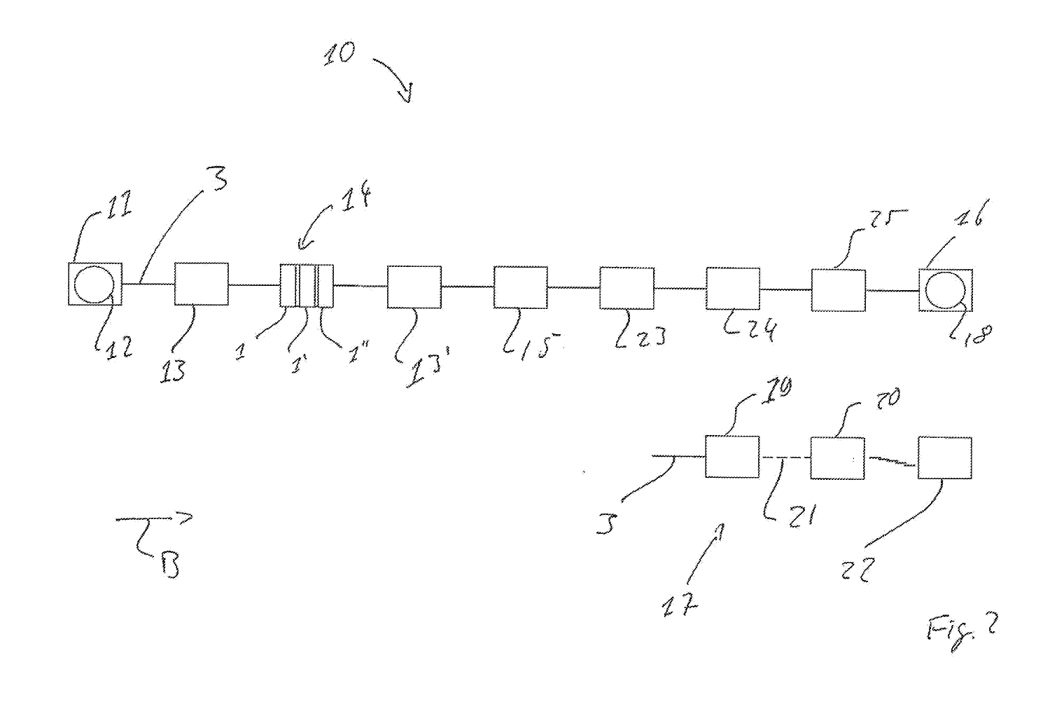

FIG. 2 shows a schematic view of an exemplary embodiment of the web offset printing machine;

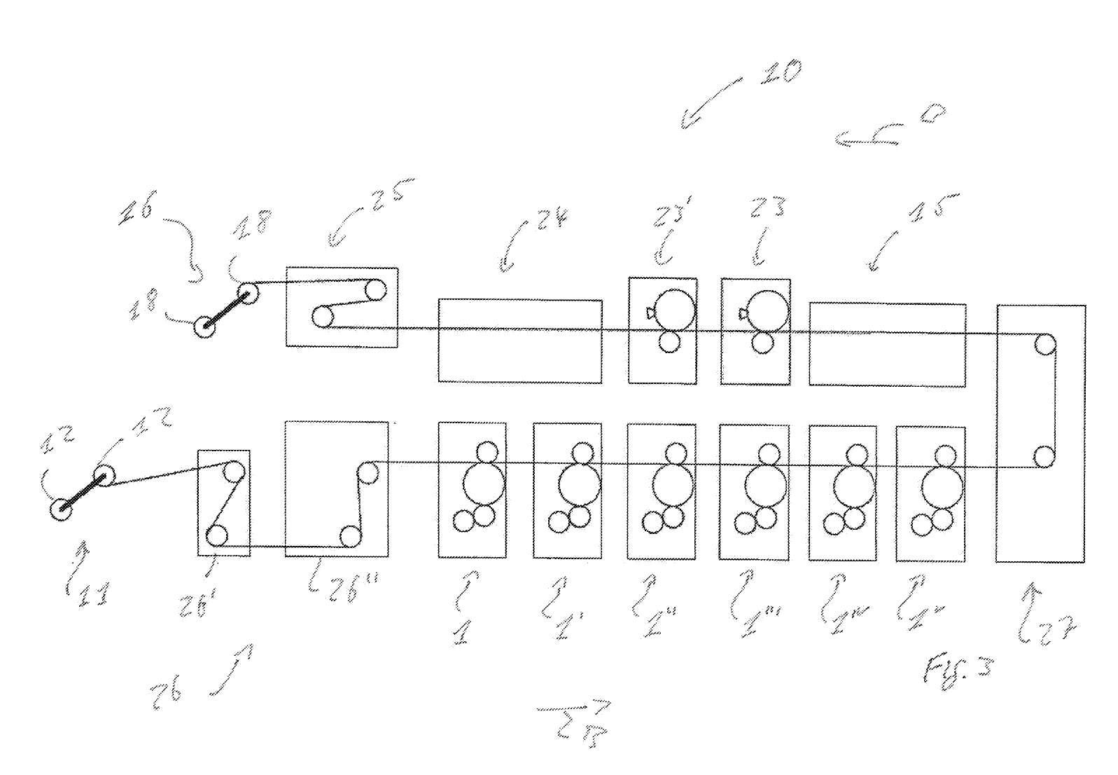

FIG. 3 shows a schematic view of another exemplary embodiment of the web offset printing machine;

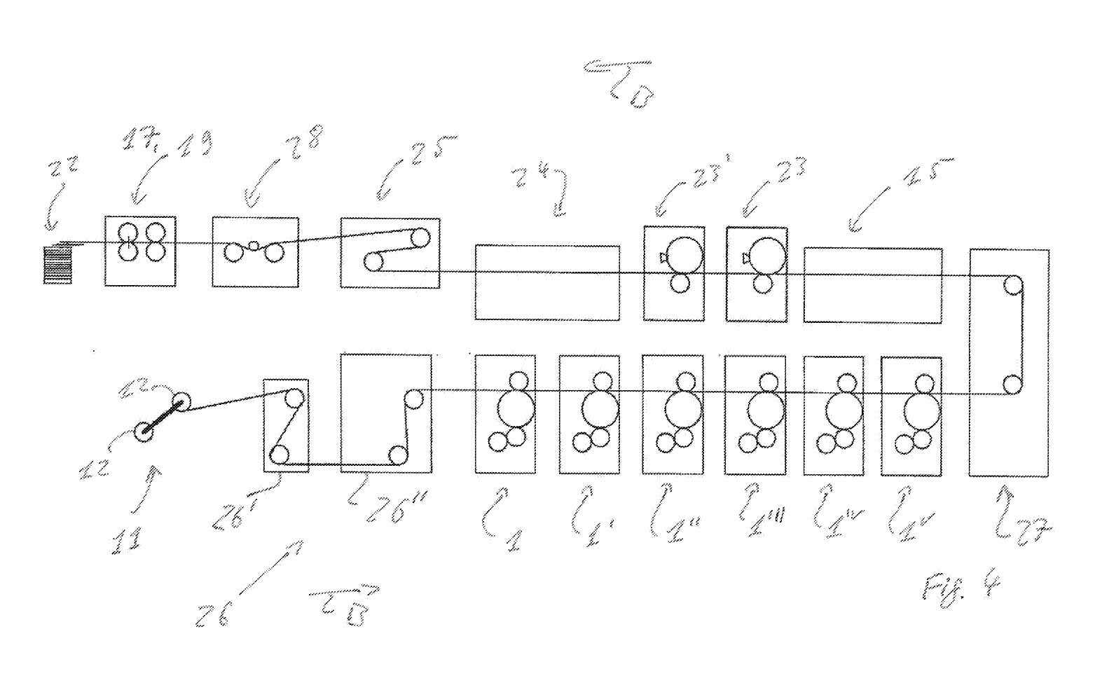

FIG. 4 shows a schematic view of another exemplary embodiment of the web offset printing machine; and

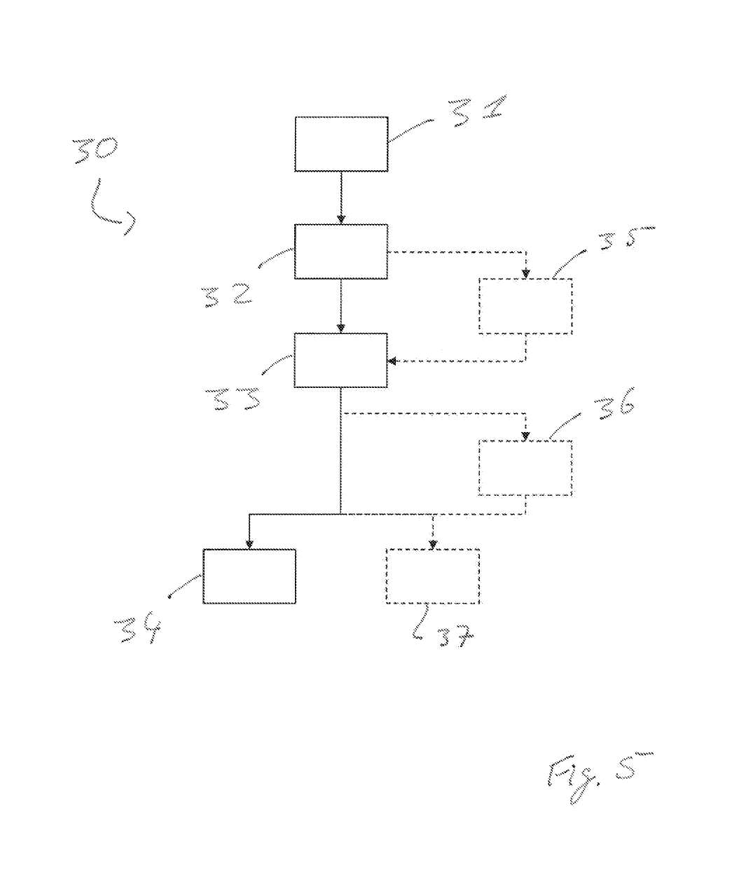

FIG. 5 shows a first exemplary embodiment of a method according to the invention in a schematic view.

Firstly the structure and function of a printing mechanism 1 of the web offset printing machine according to the invention is described with reference to the exemplary embodiment of FIG. 1.

The printing mechanism 1 is shown standing on a floor 2, for example, of a factory building. In a processing direction B a material web 3 of flat material is supplied to the printing mechanism 1 and runs through the printing mechanism 1. The material web 3 extends contrary to the processing direction B as far as a roll on which the material web 3 is rolled up until it is printed with the printing mechanism 1. The material web 3 is supplied to the printing mechanism 1 as so-called endless web, the maximum length of which corresponds to the total length of material web 3 rolled up on the roll. The printing mechanism 1 is configured to transport the material web 3 in the operating direction B.

In order to be able to print the material web 3 with a printing ink, the printing mechanism 1 is configured with a printing cylinder 4. The printing cylinder 4 is, for example, configured with a flexible surface in order to be able to apply the printing ink to the material web 3. The flexible surface of the printing cylinder 4 can, for example, be a rubber cloth or sleeve which is wound around the printing cylinder 4 or drawn onto the printing cylinder 4 and fastened to this. During operation the flexible surface must not be operated dry, i.e. without printing ink, for a fairly long time since it warms up rapidly when operated dry and as a result ages rapidly.

Located opposite the printing cylinder 4 transversely to the processing direction B is a counterpressure cylinder 5. The material web 3 which can be pressed by the counterpressure cylinder 5 against the printing cylinder 4 runs between the printing cylinder 4 and the counterpressure cylinder 5 during operation of the printing mechanism 1. The counterpressure cylinder 5 is configured to be operated dry, i.e. without being wetted with printing ink. For example, the counterpressure cylinder 5 is provided with a metallic lateral surface which during operation as a pressure surface presses the material web 3 against the printing cylinder 4. The counterpressure cylinder 5 can optionally be configured to cool its lateral surface during operation.

A plurality of and, for example three, rollers 6 transport printing ink from a printing ink container 7 to a plate cylinder 8 which delivers selected parts of the printing ink to the printing cylinder 4. The rollers 6 abut against one another and against the plate cylinder 8 and transfer the printing ink onto one another and onto the plate cylinder 8 through coupled rotation, where the printing ink is distributed uniformly onto the surface of the plate cylinder 8.

FIG. 2 shows schematically an exemplary embodiment of the web offset printing machine 10 according to the invention where the same reference numbers are used for elements which correspond in function and/or structure to the elements of the exemplary embodiment of FIG. 1. For the sake of brevity, only the differences from the exemplary embodiment of FIG. 1 will be discussed.

The web offset printing machine 10 is shown with an unrolling module 11 which holds a roll 12 of material web 3 to be printed. The unrolling module 11 can, for example, be a roll changer and in particular can be a so-called autopaster or standstill roll changer.

In the processing direction B a clamping module 13 is located downstream of the unrolling module 11, to which the material web 3 unrolled from the roll 12 is supplied. The clamping module 13 can be a pre-tensioning unit by which means the mechanical tension of the unrolled material web 3 supplied to the printing mechanism 1 can be changed.

In the processing direction B behind the clamping module 13 the web offset printing machine 10 comprises a printing apparatus 14 for printing the material web 3. The material web 3 is shown supplied to the printing apparatus 14 by the clamping module 13 in the processing direction B. The printing apparatus 14 can have at least one printing mechanism 1 for printing the material web 3 on one side. In order to be able to apply a plurality of inks to the material web 3, the printing apparatus 14 can however also have a plurality of and for example three, four, five or more printing mechanisms 1, 1′, 1″ which can printing material webs 3 consisting of board or liner on one side and to which the material web 3 is supplied successively during operation.

If the printing ink printed onto the material web 3 is to be dried, the web offset printing machine 10 can be configured with a drying device 15 to which the printed material web 3 is supplied from the printing apparatus 14.

In order to be able to adjust the tension of the material web 3 after the printing apparatus 14, the web offset printing machine 10 can have another clamping module 13′ which receives the material web 3 from the printing apparatus or the drying device 15.

If the printed material web 3 is to be supplied to another processing machine after printing in the printing apparatus 14 without further processing by the web offset printing machine 10, after leaving the printing apparatus 14 the material web 3 can be supplied, for example, to a rolling-up module 16 or a cutting device 17. With the rolling-up module 16 the material web 3 can be rolled up into a roll 18 of printed material web 3. The cutting device 17 can cut the material web 3 longitudinally and/or transversely into pieces. For cutting the material web 3 transversely to the processing direction B, the cutting device 17 of the exemplary embodiment of FIG. 2 is configured with a transverse cutter 19. Located downstream of the transverse cutter 19 in the processing direction B is an overlapping device 20 in which the printed products 21 cut out from the material web 3 are overlapped with one another. A stacker 22 following the overlapping device 20 in processing direction B receives the printed products 21 and aligns them with respect to one another as a stack. The web offset printing machine 10 can be configured in this case so that the rolling-up module 16 and the cutting device 17 can be exchanged for one another if required.

In order for example to change the visual impression of the printing, the printed and optionally dried material web 3 can be supplied to a coating module 23 directly or indirectly following the printing apparatus 14 in the processing direction B. The material web 3 can be coated with the coating module 23 so that the printed side of the material web 3 shines for example. This is particularly desirable when manufacturing outer sides of sales packagings.

The printing apparatus 14 or the drying device 15 located downstream of the printing apparatus 14 can be formed with a transfer mechanism with which the printed material web 3 can be automatically transferred to the coating module 23. Alternatively or additionally the coating module 23 can have a transporting or transfer mechanism which receives the printed material web 3 and transports it through the coating module 23. The printed material web 3 therefore does not need to be transported manually between the printing apparatus 14 and the coating module 23.

In order to be able to dry the coating applied in the coating module 23 as rapidly as possible, the web offset printing machine 10 can have a drying device 24 which is located downstream of a locating unit of the coating module 23. The drying device 24 receives the coated material web 3 from the coating unit and dries the coating.

As a result of the drying of the coating in the drying device 24, the material web 3 can be heated so strongly that it is not easily be rolled into the roll 18 or cut into the printed products 21. Consequently the web offset printing machine 10 can be configured with a cooling module 25 which cools the material web 3 during operation between the drying device 24 and the rolling-up module 16 or the cutting device 17. Additionally or alternatively to the cooling module 25 a cooling module can receive and cool the dried printed material web 3 after the drying device 15.

FIG. 3 shows another exemplary embodiment of the web offset printing machine 10 according to the invention in a schematic view. The same reference numbers are used for elements which correspond in function and/or structure to the elements of the exemplary embodiments shown in the previous figures. For the sake of brevity, only the differences from the previous exemplary embodiments will be discussed in the following.

FIG. 3 shows the web offset printing machine 10 with an unrolling module 11 which is configured as a roll changer and which is fitted with two rolls 12. In the processing direction B the unrolling module 11 is followed by a feeding device 26 which preferably comprises a feeding unit 26′ and following this a Pilger step feeding unit 26″. The feeding unit 26′ receives the unrolled material web 3 from the unrolling module 11 and passes this onto the Pilger step feeding unit 26″.

The Pilger step feeding unit 26″ enables the web offset printing machine 10 to be operated continuously between the unrolling module 11 and the Pilger step feeding unit 26″. In the processing direction B behind the Pilger step feeding unit 26″ the material web 3 can be handled discontinuously and, for example, guided at intervals.

In particular in the processing direction B the web offset printing machine 10 has a plurality of, and for example, six printing mechanisms 1, 1′, 1″, 1′″, 1^{iv}, 1^{v} through which the material web 3 can be guided discontinuously for printing. For example, the printing of the material web 3 can be stopped without the continuous unrolling of the material web 3 needing to be stopped. Thus it is possible to stop the material web 3 during printing when the section of the material web 3 to be printed is printed. If the section to be printed is shorter than the circumference of the printing cylinder 4 or the length of a printing plate mounted on the printing cylinder 4, the printing process can be continued as soon as the printing cylinder 4 has completely completed its revolution or plurality of revolutions.

In order to be able to continue the printing at a predefined point on the material web 3, the material web 3 can be withdrawn contrary to the processing direction B before the printing process is continued and for example, before the printing cylinder 4 has completed its revolution.

In order to be able to continuously further process the material web 3 behind the last printing mechanism 1″, the web offset printing machine can have a Pilger step extraction unit 27 behind the printing mechanism 1″ in the processing direction B. The Pilger step extraction unit 27 receives the discontinuously guided material web 3 from the printing mechanism 1″ and continuously delivers the material web 3 in the processing direction B. The material web 3 can be operated discontinuously as far as the Pilger step extraction unit 27 and continuously after the Pilger step extraction unit 27 and in particular can be transported and coated.

The Pilger step extraction unit 27 can be followed in the processing direction B by the drying device 15 in which the one-sided printing of the material web 3 is at least partially dried. In the exemplary embodiment of FIG. 3 the dried material web 3 is supplied to the coating module 23 in which the material web 3 and in particular its printing can be coated with a coating. The coating module 23 can be followed by another coating module 23′ to which the coated material web 3 is supplied during operation.

According to the exemplary embodiment shown, the coated material web 3 is supplied after its coating to the drying device 24 which, for example, is disposed in the processing direction B after the coating module 23 or the coating module 23′. The drying device 24 can be followed by the cooling module 25 in which the material web 3 with the dried coating can be cooled before the further processing. The cooling module 25, for example, has at least one and in particular two or more cooling rolls which contact the material web 3 during operation and thereby remove heat from the material web 3. Located after the cooling module 25 is the rolling-up module 16 on which the printed and coated material web 3 can be rolled up into a roll 18. The rolling-up module 16 is shown as a roll changer on which, for example, two rolls 18 can be rolled up successively.

FIG. 4 shows another exemplary embodiment of the web offset printing machine 10 according to the invention in a schematic view. The same reference numbers are used for elements which correspond in function and/or structure to the elements of the exemplary embodiment shown in FIG. 3. For the sake of brevity only the differences from the exemplary embodiment of FIG. 3 are discussed in the following.

The web offset printing machine 10 of the exemplary embodiment of FIG. 4 substantially corresponds to the web offset printing machine 10 of the exemplary embodiment of FIG. 3 from the unrolling module 11 as far as the cooling module 25. In the exemplary embodiment of FIG. 4 the web offset printing machine 10 has an optional smoothing device 28 behind the cooling module 25 in the processing direction B in which the printed and coated material web 3 can, for example, be mechanically smoothed if the one-sided printing and/or the one-sided coating results in an irregular warpage, for example, curving of the material web 3. Furthermore, the web offset printing machine 10 in the exemplary embodiment shown is provided with the cutting device 17 which is configured as a transverse cutter 19. The cutting device 17 separates the material web 3. Individual pieces of the material web 3 can be stacked by means of a stacker 22 which follows the cutting device 17 in the processing direction B. The rolling-up module 16 is not required for the web offset printing machine 10 of the exemplary embodiment in FIG. 4 but can be configured to be connectable and operable with the cooling module, for example, instead of the cutting device 17 and the stacker 22 as well as optionally instead of the smoothing device 28.

The components of the exemplary embodiments described can form a web offset printing system where at least selected components and in particular the rolling-up module 16 on the one hand the cutting device 17 and the stacker 22 and optionally the smoothing device 28 on the other hand can be exchanged in a modular manner for one another.

FIG. 5 shows a first exemplary embodiment of a method for printing a material web 3 according to the invention. The same reference numbers are used for elements which correspond in function and/or structure to the elements of the exemplary embodiment shown in the previous figures. For the sake of brevity only the differences from the previous exemplary embodiments are discussed in the following.

FIG. 5 shows the method according to the invention schematically as a flow diagram. The method 30 starts with a first process step 31 in which a material web 3 rolled up on a roll 12 is unrolled. In the following process step 32 a section of the material web 30 unrolled from the roll 12 is printed on one side. The process step 32 is followed by a process step 33 in which the printed material web 3 is coated and, for example, varnished. Preferably only the printed side of the material web 3 is coated. Following the coating, the material web 3 is rolled into a roll 18 in process step 34.

The process 30 can comprise further optional process steps. For example, a further process step 35, 36 can be provided between the process steps 32 and 33 and/or after the process step 33, in which the printed or coated material web 3 is dried. After the material web 3 has been dried in one of the process steps 35, 36 and for this purpose has for example been heated or irradiated, the material web 3 can optionally be cooled in further process steps which are not shown for simplicity. Instead of the process step 34 in which the printed and coated material web 3 is rolled up into the roll 18, the process 30 can also comprise a process step 37 in which the printed and coated material web 3 is separated and cut for this purpose for example. Before the process step 37 the printed and/or coated material web 3 can be smoothed in order to obtain flat pieces of material web after process step 37.

During printing 32 the material web 3 can be stopped. As a result it is possible to print a section of the material web 3 whose length running in the processing direction B differs from the circumference of the printing cylinder 4 or from the length of the printing plate mounted on the printing cylinder 4 and in particular is smaller than the circumference. Transport of the material web 3 in the processing direction B is preferably suspended until the printing cylinder 4 has completed its revolution. Before the printing process 32 is continued, the material web 3 can be positioned with respect to the printing cylinder 4, in particular so that the printing can be continued smoothly. For positioning the material web 3 can, for example, be pulled contrary to the processing direction B.

1. A web offset printing machine (10) for printing a flat material web (3) of cardboard or liner for corrugated board or packagings, which is unrolled from a roll (12), comprising at least one printing mechanism (1) for printing an unrolled section of the material web (3) and comprising an unrolling apparatus (11) for unrolling the material web (3) from the roll (12) and for supplying the unrolled material web (3) to the printing mechanism (1) characterized in that the web offset printing machine (10) is configured with a coating module (23) for coating the printed material web (3) on one side, wherein the coating module (23) is located downstream of the printing mechanism (1).

2. The web offset printing machine (10) according to claim 1, characterized in that the coating module (23) comprises a coating unit which coats the printed material web (3) on one side during operation.

3. The web offset printing machine (10) according to claim 1, characterized in that the web offset printing machine (10) has a rolling-up module (16) for rolling up the printed and coated material web (3) onto a roll (18).

4. The web offset printing machine (10) according to claim 1, characterized in that the web offset printing machine (10) has a cutting device (17) for cutting flat printed products (21) from the printed and coated material web (3).

5. The web offset printing machine (10) according to claim 1, characterized in that the coating module (23) is configured with a transport mechanism which receives the printed material web (3) and transports it through the coating module (23).

6. The web offset printing machine (10) according to claim 1, characterized in that the printing mechanism (1) is configured to print the unrolled material web (3) on one side, wherein the printing mechanism (1) is configured for this purpose with a printing cylinder (4) for printing the material web (3) on one side and with a counterpressure cylinder (5) for pressing the material web (3) onto the printing cylinder (4).

7. The web offset printing machine (10) according to claim 1, characterized in that the printing mechanism (1) is configured for transporting the unrolled material web (2) in a processing direction (B).

8. The web offset printing machine (10) according to claim 1, characterized in that the web offset printing machine (10) comprises a drying device (15) which is located downstream of the printing mechanism (1) and which is configured to dry the printed material web (3).

9. The web offset printing machine (10) according to claim 8, characterized in that the web offset printing machine (10) comprises a cooling module (25) located downstream of the drying device (15, 24) for cooling the dried material web (3).

10. The web offset printing machine (10) according to claim 1, characterized in that the web offset printing machine (10) is configured to print sections of the material web (3) of different length.

11. The web offset printing machine (10) according to claim 1, characterized in that the web offset printing machine (10) is configured to print sections of the material web (3) having a length differing from the circumference of the printing cylinder (4).

12. A method (30) for printing a flat material web (3) of cardboard or liner for corrugated board or packagings, wherein the material web (3) is unrolled (31) from a roll (12) and an unrolled section of the material web (3) is printed (32), characterized in that the printed section is coated on one side (33).

13. The method according to claim 12, characterized in that the material web (3) is printed on one side (32).

14. The method (30) according to claim 12, characterized in that the material web (3) is stopped during printing until a printing cylinder (4) has completed a revolution.

15. The method (30) according to claim 14, characterized in that the material web (3) is withdrawn contrary to a processing direction (B) before the printing cylinder (4) has completed a revolution.
